(19) United States
(12) Patent Application Publication
(10) Pub. No.: US 2014/0000576 A1
(43) Pub. Date: Jan. 2, 2014

(54) CHASSIS MOUNT MULTI-INPUT H-BRIDGE ELECTRICAL HARNESS

(71) Applicant: CONTINENTAL AUTOMOTIVE SYSTEMS, INC., Auburn Hills, MI (US)

(72) Inventors: Craig Andrew Weldon, Chatham (CA); Richard Bogl, Windsor (CA); Bernie D. Watson, Delevan, WI (US); David Koen, Delevan, WI (US); William J Boucher, Chatham (CA)

(73) Assignee: Continental Automotive Systems, Inc., Auburn Hills, MI (US)

(21) Appl. No.: 13/872,509

(22) Filed: Apr. 29, 2013

Related U.S. Application Data
(60) Provisional application No. 61/666,021, filed on Jun. 29, 2012.
(60) Provisional application No. 61/677,241, filed on Jul. 30, 2012.

(51) Int. Cl. F02D 41/00; H02P 8/00

(52) U.S. Cl. CPC F02D 41/00; H02P 8/005
USPC 123/704; 318/696

(57) ABSTRACT

An integrated H-bridge electrical harness for controlling an actuator, such as a stepper motor, where the harness includes a signal converter in electrical communication with an ECU, a driver in electrical communication with the signal converter, and a plurality of connectors. At least one of the connectors provides a connection with the ECU, and another of the connectors provides a connection with an actuator. The signal converter receives a first type of signal (such as a pulse width modulated signal) from the ECU, and converts the first type of signal to a second type of signal, and the signal converter sends the second type of signal to the driver. The driver sends a third type of signal (such as a double square wave signal) to the actuator to control the actuator.

### CROSS-REFERENCE TO RELATED APPLICATIONS

This application claims the benefit of U.S. Provisional Application No. 61/666,021 filed Jun. 29, 2012, and U.S. Provisional Application No. 61/677,241, filed Jul. 30, 2012. The disclosures of the above applications are incorporated herein by reference.

### FIELD OF THE INVENTION

The invention relates generally to an H-bridge electrical harness for providing a connection between an engine controller and a digital linear actuator, such as a stepper motor.

### BACKGROUND OF THE INVENTION

Stepper motors, such as bipolar stepper motors, require a double square wave signal for proper operation. This double square wave signal is typically produced from an L/R driver, such as an electrical H-bridge driver. For many vehicle platforms, engine control units (ECU) have limited architecture in the output signals available, and cannot provide the required drive signals (such as a double square wave signal) to control a stepper motor. Unfortunately, due to ECU packaging constraints or cost, it is often not possible to integrate the H-bridge driver into an ECU. For stepper motors, such as a digital linear actuator (DLA), a dedicated supplementary electrical controller is required for use on these vehicles lacking a driver integrated into the ECU.

Furthermore, attempts to incorporate a DLA having an integrated H-bridge driver (to connect to the ECU) have been met with difficulty, as the DLA may be exposed to excessive vibration during operation of the engine and vehicle. Recreational vehicles such as all-terrain vehicles, snowmobiles, and the like, expose the DLA to significant amounts of engine vibration, which may disrupt the H-bridge driver integrated electronics functionality. This affects the operation of the integrated H-bridge, and therefore affects the operation of the DLA.

Accordingly, there exists a need for modularization of a driver with an Application Specific Integrated Circuit (ASIC) which allows for functional control for the DLA external to the ECU, and removes the driver from the DLA to isolate the driver from extreme engine and vehicle vibration load.

### SUMMARY OF THE INVENTION

The present invention is an electrical harness having an integrated driver for controlling an actuator, where the harness includes a signal converter in electrical communication with an ECU, a driver in electrical communication with the signal converter, and a plurality of connectors. At least one of the connectors provides a connection with the ECU, and another of the connectors provides a connection with an actuator. The signal converter receives a first type of signal (such as a pulse width modulated, or PWM, signal) from the ECU, and converts the first type of signal to a second type of signal, and the signal converter sends the second type of signal to the driver. The driver sends a third type of signal (such as a double square wave signal) to the actuator to control the actuator.

It is an object of this invention to provide a module which includes a driver, such as an H-bridge driver, with an ASIC having modularization for placement within an electrical harness. This module includes a “plug and play” feature, and thus is able to be incorporated for use with existing designs or production DLAs. The module also includes an external power source and an ECU interface signal. Modularization allows for plug and play without interference of the functionality of the ECU, and does not impact current production of the DLA.

In an embodiment, the ASIC would receive electrical inputs from the ECU. ECU input could be a communication BUS interface such as, but not limited to, the following: CAN, RS485, PWM, LIN Linear Voltage, etc. The ASIC interprets the input signal from the ECU, the ASIC then commands the H-bridge driver to produce the required output. In some embodiments of the invention, the module includes diagnostic capabilities such as motor stall indication, open circuit, low power, malfunction indicator (MIL) and others.

It is another object of this invention to provide a chassis mounted module, such that the vibration protection of the electronics would be less than as required for on-engine or direct DLA mounted electronics. Off-road and smaller engines vehicles (such as all-terrain vehicles, snow machine, etc,) may have engine vibration peaks approaching acceleration levels of one-hundred times the force of gravity, or 100 g. In one embodiment, the DLA is throttle body mounted, used for the idle air control valve (IACV), and is exposed to this extreme vibration.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is diagram of an H-bridge electrical harness, according to embodiments of the present invention; and

FIG. 2 is a table of an alternate embodiment of a duty cycle used as part of an H-bridge electrical harness, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

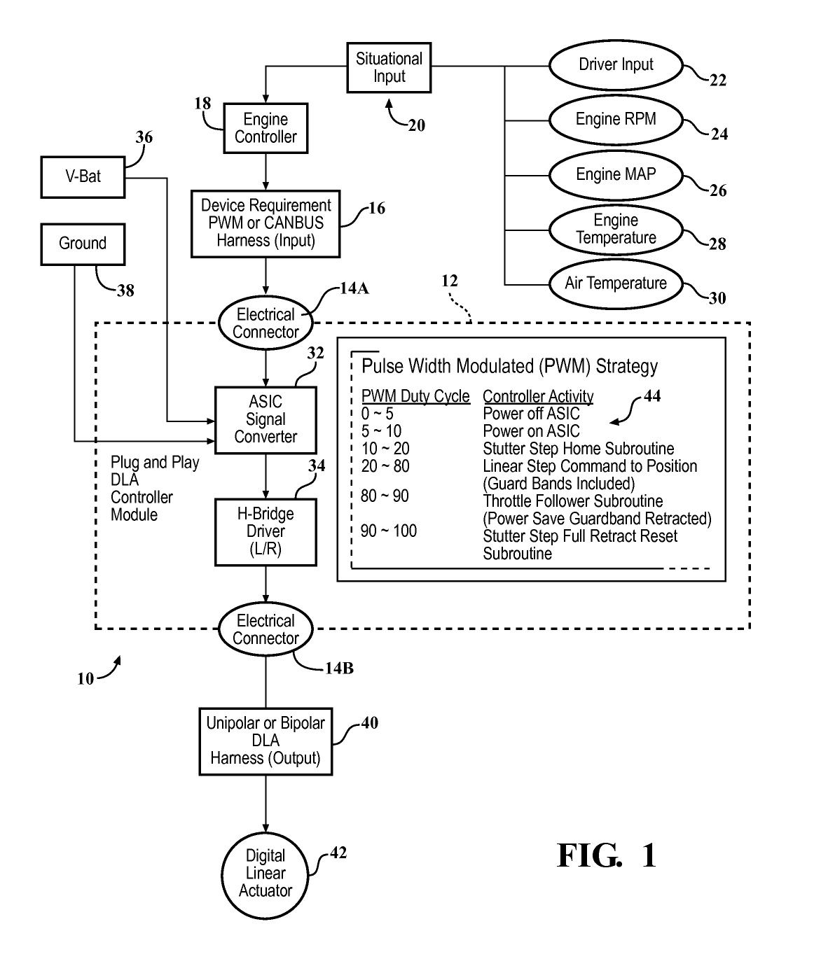

A diagram of a system having an H-bridge electrical harness for providing a connection between an engine controller and a digital linear actuator (DLA) is shown in FIG. 1 generally at 10. Shown in the system diagram 10 is an H-bridge electrical harness 12 having a first electrical connector 14A and a second electrical connector 14B. The first electrical connector 14A provides a connection with the harness 16 of an engine control unit (ECU) 18, and the ECU 18 receives situational input, shown generally at 20, indicating various conditions of the vehicle, such as, but not limited to, driver input 22, engine speed 24 in the form of RPM, engine manifold absolute pressure (MAP) 26, engine temperature 28, air temperature 30, or other combinations of input.

The harness 12 also includes an Application-Specific Integrated Circuit (ASIC) signal converter 32, which is connected to the first electrical connector 14A, and driver 34, and the driver 34 is connected to the second electrical connector 14B. In this embodiment, the driver 34 is a type of L/R driver, or more specifically, is an H-bridge driver 34. Additionally, the converter 32 is also in electrical communication with a power source 36 and a ground 38. The second electrical connector 14B is also connected to a digital linear actuator (DLA) harness 40, which is then connected to a DLA 42.

In operation, the ECU 18 is able to send a first type of signal, which in this embodiment is a pulse-width modulated (PWM) signal, to the H-bridge electrical harness 12. In other embodiments, the first signal is a communication BUS interface, such as CAN, RS485, PWM, LIN Linear Voltage, or the like. The PWM signal travels from the ECU 18, through the harness 16 of the ECU 18 and through the first electrical connector 14A. The signal is received by the signal converter 32. The signal converter 32 converts the PWM signal to a second type of signal, which in this embodiment is the proper conversion signal, and sends the second type of signal to the H-bridge driver 34.

The duty cycle of the PWM signal sent to the signal converter 32 controls the operation of the driver 34. A table of the various parts of the duty cycle is shown in FIG. 1 generally at 44. The table 44 represents the duty cycle when the DLA 42 is in the form of a stepper motor. A signal of 0-5 Hz is a “power off” signal to the converter 32, and a signal of 5-10 Hz is a “power on” signal to the converter 32. A signal of 10-20 Hz is a “stutter step home subroutine” signal, a signal of 20-80 Hz is a “linear step command to position” signal, a signal of 80-90 Hz is a “throttle follower subroutine” signal, and a signal of 90-100 Hz is a “stutter step full retract reset subroutine” signal. Although the various parts of the duty cycle in this embodiment are in the table 44, it is within the scope of the invention that other types of duty cycles may be used as well.

Once the signal converter 32 has converted the first signal to the second signal, the second signal is then sent to the H-bridge driver 34, where the H-bridge driver 34 converts the second signal to a third signal. The H-bridge driver 34 then sends the third signal, which in this embodiment, the third signal is the proper double square wave signal, to the DLA 42 through the second electrical connector 14B and the harness 40.

The ECU 18 is interfaced to the module 12 with several possibilities for situational input 20. The module 12 is connected to each harness 16,40 with adaptation for chassis mount using external hardware. This allows for “plug and play” functionality, and adaptation for use with different types of ECUs and DLAs. Mounting the harness 12 on the chassis of a vehicle, such as a smaller engine vehicle, allows for limited exposure to vibration from the vehicle operation, isolating vibration from the vehicle engine. In some embodiments, the harness 12 may include diagnostic capabilities, such as motor stall indication, open circuit, low power, malfunction indicator (MIL), and the like.

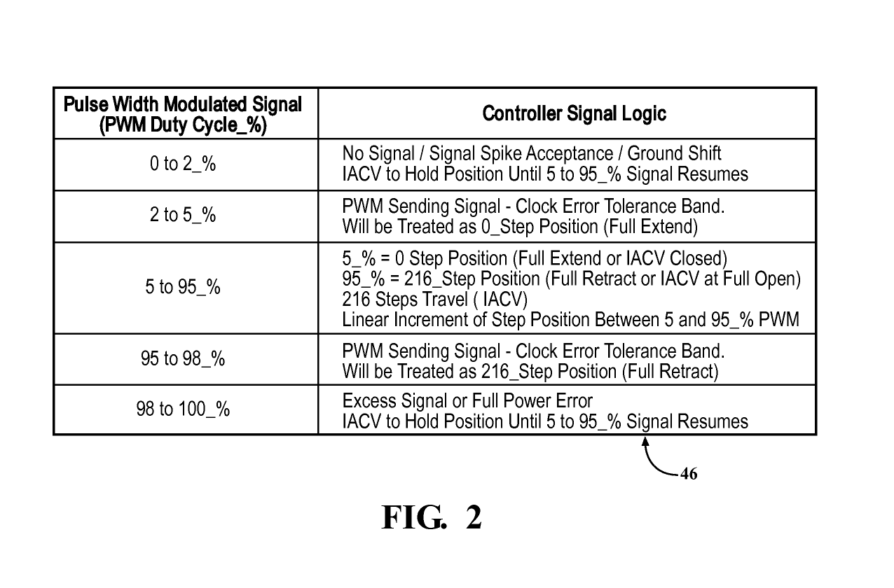

An alternate embodiment of the duty cycle for the PWM signal (sent to the signal converter 32) is shown in a second table, shown generally at 46, in FIG. 2. The second table 46 lists a duty cycle which is applicable when the DLA 42 is in the form of an idle air control valve (IACV), and the harness 12 is mounted on a throttle body. In the PWM duty cycle shown and described in the second table 46, the parts of the duty cycle and the position of the DLA 42 is also expressed as a percentage of the duty cycle, as shown in the first table 44. From zero to two percent of the duty cycle, the PWM signal is either a “no signal,” a “signal spike acceptance,” or a “ground shift” signal, where the IACV is in a “hold” position until five to ninety-five percent of the PWM signal resumes.

From two percent to five percent, the PWM signal is sent to the signal converter 32, and during this time, the IACV is positioned at a fully extended position (the IACV is closed), and is treated as a zero step position. In an alternate embodiment, a “stutter step subroutine” may also be incorporated into the duty cycle to physically locate the pintle or capnut of the IACV on a valve seat with alignment between the nearest pole plate and rotor.

From five percent to ninety-five percent, the PWM signal received by the IACV incrementally steps the IACV from a zero step position (where the IACV is closed) to a two-hundred-sixteen (216) step position, where the IACV is fully open (or fully retracted position). The steps between 0 and 216 are linear, so each step is of equal value, and the IACV may be placed in any position between step 0 and step 216.

From ninety-five percent to ninety-eight percent, the PWM signal is in the clock error tolerance band, and the IACV remains at the step 216 position, or fully retracted. From ninety-eight percent to one-hundred percent, the PWM signal sent from the ECU 18 to the signal converter 32 is an excess signal, or full power error signal. During this portion of the PWM duty cycle, the IACV remains in a hold position until the duty cycle is back between five percent and ninety-five percent.

In alternate embodiments, the H-bridge driver 34 could be replaced with a chopper driver, providing a different type of actuation for the chopper driver specific DLA 42. This would require special fabrication of the DLA 42 for use with the chopper driver, but using a chopper driver is more suitable for applications where higher toque and higher speed are required. In other alternate embodiments, the DLA 42 could also be a device connected to linkage to provide remote control over a throttle, where the H-bridge driver 34 is mounted among the throttle body linkage. In other embodiments, the H-bridge driver 34 is mounted on other devices, such as an automatic choke, or the like.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an H-bridge electrical harness for controlling an actuator, including:
a signal converter in electrical communication with an engine control unit (ECU); and
a driver in electrical communication with the signal converter;
wherein the signal converter receives a first type of signal from the ECU, and converts the first type of signal to a second type of signal, and the signal converter sends the second type of signal to the driver, and the driver sends a third type of signal(s) to an actuator to control the actuator.

2. The apparatus of claim 1, further comprising a plurality of connectors, at least one of the plurality of connectors providing a connection between the H-bridge electrical harness and the ECU, and another of the plurality of connectors providing a connection between the H-bridge electrical harness and the actuator.

3. The apparatus of claim 1, the signal converter further comprising an Application Specific Integrated Circuit (ASIC) signal converter.

4. The apparatus of claim 1, the driver further comprising an H-bridge driver.

5. The apparatus of claim 1, the first type of signal further comprising a CAN bus signal being one selected from the group consisting of CAN, RS485, PWM, LIN Linear Voltage, and combinations thereof.

6. The apparatus of claim 1, the first type of signal further comprising a pulse width modulated signal.

7. The apparatus of claim 6, the second type of signal further comprising a conversion signal.

8. The apparatus of claim 1, the actuator further comprising a digital linear actuator.

9. The apparatus of claim 8, the digital linear actuator further comprising an idle air control valve having a throttle body, the H-bridge electrical harness mounted to the throttle body.

10. The apparatus of claim 8, the digital linear actuator further comprising a stepper motor.

11. The apparatus of claim 10, the third type of signal further comprising a double square wave signal, and the double wave signal is sent to the stepper motor to control the operation of the stepper motor.

12. The apparatus of claim 11, the driver further comprising a chopper driver.

13. The apparatus of claim 12, the double square wave signal further comprising a double chopper signal.

14. The apparatus of claim 8, wherein the digital linear actuator is connected to linkage for providing remote control over a throttle.

15. The apparatus of claim 1, wherein the H-bridge electrical harness is mounted on the chassis of a vehicle.

16. An H-bridge electrical harness for controlling an actuator, comprising:
a signal converter in electrical communication with an engine control unit (ECU);
a driver in electrical communication with the signal converter and a digital linear actuator; and
a plurality of connectors, at least one of the plurality of connectors providing a connection with the ECU, and another of the plurality of connectors providing a connection with a digital linear actuator;
wherein the signal converter receives a first type of signal from the ECU, and converts the first type of signal to a second type of signal, and the signal converter sends the second type of signal to the driver, and the driver sends a third type of signal to the digital linear actuator to control the digital linear actuator.

17. The H-bridge electrical harness for controlling an actuator of claim 16, the signal converter further comprising an Application Specific Integrated Circuit (ASIC) signal converter.

18. The H-bridge electrical harness for controlling an actuator of claim 16, the driver further comprising an H-bridge driver.

19. The H-bridge electrical harness for controlling an actuator of claim 16, the first type of signal further comprising a CAN bus signal being one selected from the group consisting of CAN, RS485, PWM, LIN Linear Voltage, and combinations thereof.

20. The H-bridge electrical harness for controlling an actuator of claim 16, the first type of signal further comprising a pulse width modulated signal, the second type of signal further comprising a conversion signal.

21. The H-bridge electrical harness for controlling an actuator claim 20, the digital linear actuator further comprising a stepper motor.

22. The H-bridge electrical harness for controlling an actuator of claim 21, the third type of signal further comprising a double square wave signal, and the double wave signal is sent to the stepper motor to control the operation of the stepper motor.

23. The H-bridge electrical harness for controlling an actuator of claim 22, the driver further comprising a chopper driver.

24. The H-bridge electrical harness for controlling an actuator of claim 23, the double square wave signal further comprising a double chopper signal.

25. The H-bridge electrical harness for controlling an actuator of claim 16, the digital linear actuator further comprising an idle air control valve having a throttle body, the H-bridge electrical harness mounted to the throttle body.

26. The H-bridge electrical harness for controlling an actuator of claim 16, wherein the digital linear actuator is connected to linkage for providing remote control over a throttle.

27. The H-bridge electrical harness for controlling an actuator of claim 16, wherein the H-bridge electrical harness is mounted on the chassis of a vehicle.

28. A system for transmitting a signal from an engine controller to a digital linear actuator, comprising:
an engine control unit for sending a pulse width modulated signal;
an H-bridge electrical harness having a signal converter and an H-bridge driver, the H-bridge electrical harness in electrical communication with the engine control unit such that the signal converter receives the pulse width modulated signal from the engine control unit; and
a digital linear actuator in electrical communication with the H-bridge electrical harness;
wherein the signal converter converts the pulse width modulated of signal to a conversion signal, sends the conversion signal to the H-bridge driver such that the H-bridge driver then sends a double square wave signal to the digital linear actuator to control the digital linear actuator.

29. The system for transmitting a signal from an engine controller to a digital linear actuator of claim 28, the H-bridge electrical harness further comprising a plurality of connectors, one of the of the plurality of connectors providing a connection with the engine control unit, and another of the plurality of connectors providing a connection with the actuator.

30. The system for transmitting a signal from an engine controller to a digital linear actuator of claim 28, the signal converter further comprising an Application Specific Integrated Circuit (ASIC) signal converter.

31. The system for transmitting a signal from an engine controller to a digital linear actuator of claim 28, further comprising the H-bridge electrical harness being mounted on the chassis of a vehicle.

32. The system for transmitting a signal from an engine controller to a digital linear actuator of claim 31, the digital linear actuator further comprising an idle air control valve having a throttle body, the H-bridge electrical harness mounted to the throttle body.

33. The system for transmitting a signal from an engine controller to a digital linear actuator of claim 28, the digital linear actuator further comprising a stepper motor.
